(19) United States
(12) Patent Application Publication
(10) Pub. No.: US 2005/0092869 A1
(43) Pub. Date: May 5, 2005

(54) System and method for mounting in-vehicle electronics

(75) Inventor: Alex D. Vandertol, Grandville, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/697,379

(22) Filed: Oct. 30, 2003

(51) Int. Cl. G12B 9/00

(52) U.S. Cl. 248/27.1

(57) ABSTRACT

A system for mounting an electronic device in a vehicle interior includes a base member having an aperture configured to receive the electronic device therein, at least one mounting surface provided on the base adjacent the aperture, a mounting structure extending from the electronic device and configured to interface with the mounting surface, and a cover having a clamping portion configured to secure the mounting structure between the mounting surface and the cover when the cover is coupled to the base.

### BACKGROUND

The present invention relates generally to systems and methods for mounting in-vehicle electronics. The present invention more specifically relates to improved mounting arrangements for electronics such as digital versatile disks (DVD) players and compact disk (CD) players in vehicle interiors.

Conventional in-vehicle electronics (such as DVD and CD players) are typically designed to be attached within a metal housing or “box” having generally standardized sizes and attachment structures for mounting in-vehicle electronics modules therein. The boxes with the electronics modules therein are typically installed in an instrument panel or in an overhead mounting arrangement. Conventional DVD players for automotive interior applications are typically mounted within standard boxes that are recessed within a corresponding portion of the interior trim of vehicle (e.g., instrument panel, center stack, etc.). However, certain in-vehicle electronics impose operational restrictions requiring that certain surfaces (such as a bottom surface) of the electronics may not contact any other components or surfaces. Such electronics may have portions of the electronics package which cannot contact other components or members because of operational requirements, improper functioning or operation of the electronics if a surface were to contact another object, etc. One such example are certain DVD players which have a bottom surface that moves up and down with insertion of a disk. Such DVD players cannot come into contact with any other parts on that bottom surface.

Accordingly, it would be advantageous to provide a system and method for mounting in-vehicle electronics without contacting certain surfaces (such as a bottom surface) of the electronics. It would further be advantageous to provide a system and method for mounting in-vehicle electronics that would securely hold the electronics. It would further be advantageous to provide a system and method for mounting in-vehicle electronics which would reduce the cost and/or weight of the assembly. It would further be advantageous to provide a system and method for mounting in-vehicle electronics which would improve vibration performance (such as tolerance to vibration) for the electronics. It would further be advantageous to provide a system and method for mounting vehicle electronics that the use of metal boxes.

It would be desirable to provide a system and method for mounting in-vehicle electronics of a type disclosed in the present application that provides any one or more of these or other advantageous features.

### SUMMARY

One embodiment of the invention relates to a mounting structure for an electronic device adapted for use in a vehicle interior and includes a base coupled to a structure of the vehicle interior and having an aperture therein, a cover coupled to the base, so that at least one projection extending from the electronic device is clamped between the base and the cover when the electronic device is positioned in the aperture and the cover is coupled to the base.

Another embodiment of the invention relates to a method of assembling an electronic device having at least one projection for mounting in a vehicle interior and includes the steps of coupling a base to a portion of the vehicle interior, the base having a platform portion configured for placement of the projection thereon, and coupling a cover member to the base so that the projection is captured between the platform and the cover member and a surface of the electronic device is substantially free of contact the base and the housing.

Another embodiment of the invention relates to a system for mounting an electronic device in a vehicle interior and includes a base member having an aperture configured to receive the electronic device therein, at least one mounting surface provided on the base adjacent the aperture, a mounting structure extending from the electronic device and configured to interface with the mounting surface, and a cover having a clamping portion configured to secure the mounting structure between the mounting surface and the cover when the cover is coupled to the base.

### BRIEF DESCRIPTION OF THE DRAWINGS

FIG. 1 is a front perspective view of an assembly for mounting in-vehicle electronics according to a preferred embodiment.

FIG. 2 is a top perspective view of the assembly shown in FIG. 1.

FIG. 3 is an exploded perspective view of the assembly shown in FIG. 1.

FIG. 4 is a detailed perspective view of a base and cover of the assembly shown in FIG. 1 for mounting in-vehicle electronics.

FIG. 5 is a detailed perspective view of a first mounting arrangement of the assembly shown in FIG. 1.

FIG. 6 is a detailed perspective view of a second mounting arrangement of the assembly shown in FIG. 1.

FIG. 7 is a detailed cross-section view of the assembly shown in FIG. 2 taken along the line 7-7.

FIG. 8A is a cross-section view of a portion of the assembly shown in FIG. 7.

FIG. 8B is a cross-section view of another portion of the assembly shown in FIG. 7.

### DETAILED DESCRIPTION

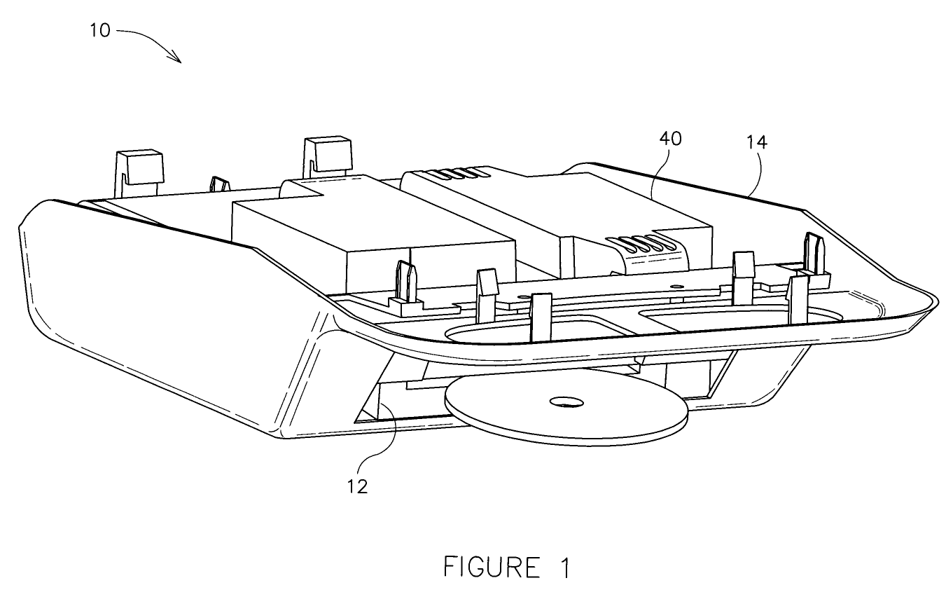

Referring to FIG. 1, an assembly 10 is shown for mounting an electronic device 12 in a vehicle interior. Electronic device 12 may be any of a variety of devices, typically used for providing in-vehicle entertainment such as digital versatile disk (DVD) players, compact disk (CD) players, etc. Alternatively, the device may be other electronic devices which are typically mounted within standard boxes that are recessed within a corresponding portion of the interior trim of vehicle (e.g., overhead console, floor console, instrument panel, center stack, etc.), etc.

According to an exemplary embodiment, electronic device 12 is a DVD drive/player. Although the electronic device is shown and described as a DVD drive/player, any electronic device suited for mounting within a vehicle interior may be provided according to alternative embodiments.

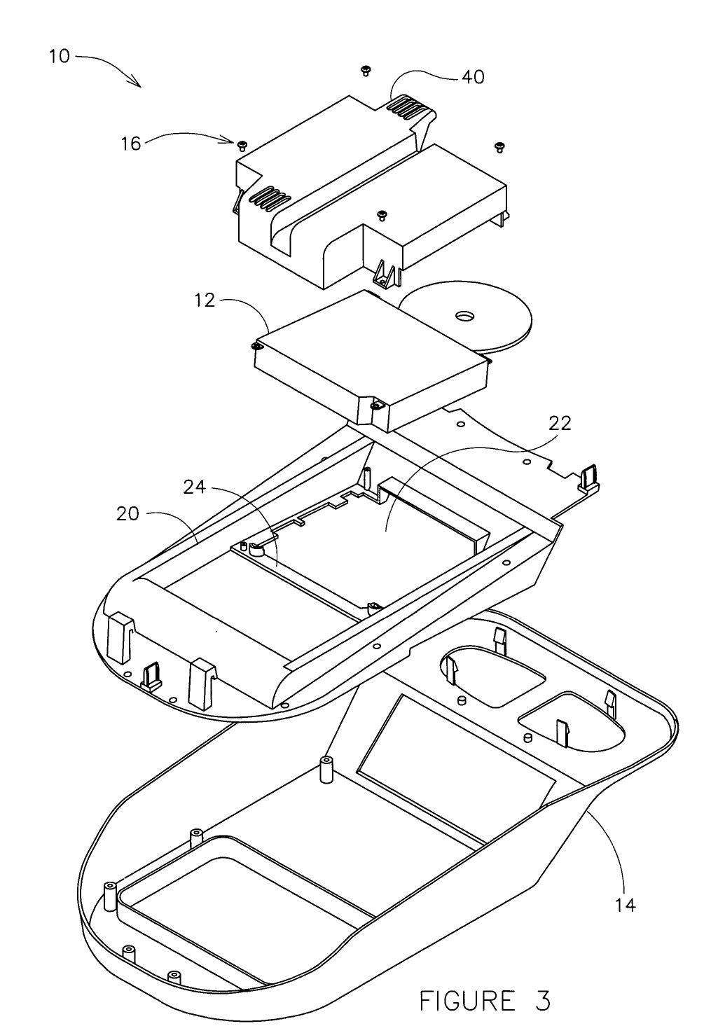

Referring to FIGS. 1 through 3, assembly 10 is shown as including a housing 14 (e.g. trim piece, holder, etc.), a base 20 (e.g. receiving structure, retainer bracket, support member, frame, etc.), a cover 40 (e.g. bracket, clamping member, etc.), couplers (shown schematically as fasteners 16) and an electronic device 12 (shown as a DVD drive/player).

The housing 14 provides a trim piece or member having an “exposed side” generally facing the vehicle interior and that is intended to at least partially conceal, and to improve the aesthetic appearance of, the assembly when viewed from an interior portion (e.g. cabin, etc.) of the vehicle and provides suitable attachment structure (e.g. apertures, bosses, etc.) on a “concealed side” for mounting the base 20 thereto. The housing may also include suitable structure (e.g. contours, recesses, bosses, brackets, etc.) for mounting or containing other structure or components useful with the vehicle interior (such as, for example, storage compartments, latches, instruments, illumination devices, etc.). The housing may be coupled to an internal structure of the vehicle (e.g. overhead structure, panel, floor, instrument cluster, center stack, etc.) by suitable connecting devices, shown as resilient mounting tabs or clips or “pushnuts” (such as Z-axis clips—not shown) configured to engage corresponding apertures (not shown) located on a structure of the vehicle interior. According to a preferred embodiment, housing 14 is made from plastic (such as ABS plastic, etc.) by a molding process (such as injection molding, etc.) and may be provided in any suitable color to accent a color scheme for the vehicle interior.

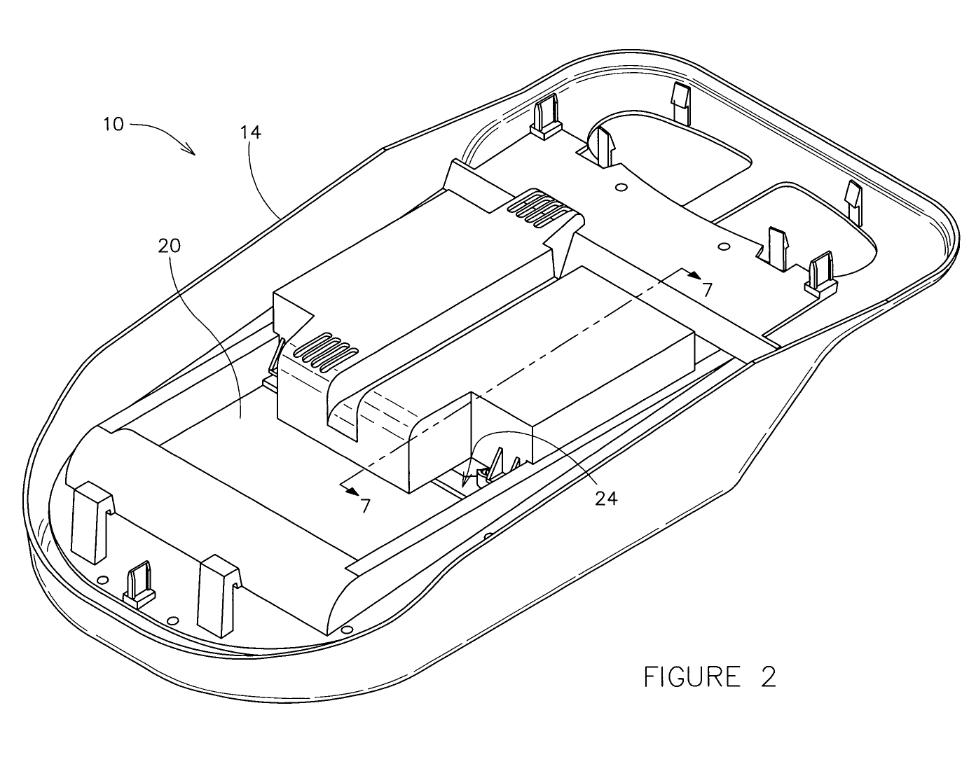

Referring to FIGS. 2 through 4, the base 20 is provided having suitable structure (e.g. alignment tabs, ridges, bosses, ribs, etc.) and contours for mounting upon, or attachment to, the “concealed side” of housing 14. Base 20 includes an aperture 22 (e.g. opening, passage, cutout, etc.) configured to accommodate mounting of electronic device 12 therein, so that a bottom surface of electronic device 12 is suspended or otherwise positioned to avoid contact with the concealed side of housing 14. Other apertures may be provided within base, such as for routing of conductors from the vehicle to the electronic device (e.g. wires for power, voice, signal, data, etc., and electrical connectors), and for providing ventilation to the electronic device, and for providing access to the electronic device for use/operation by a user or other occupant of the vehicle.

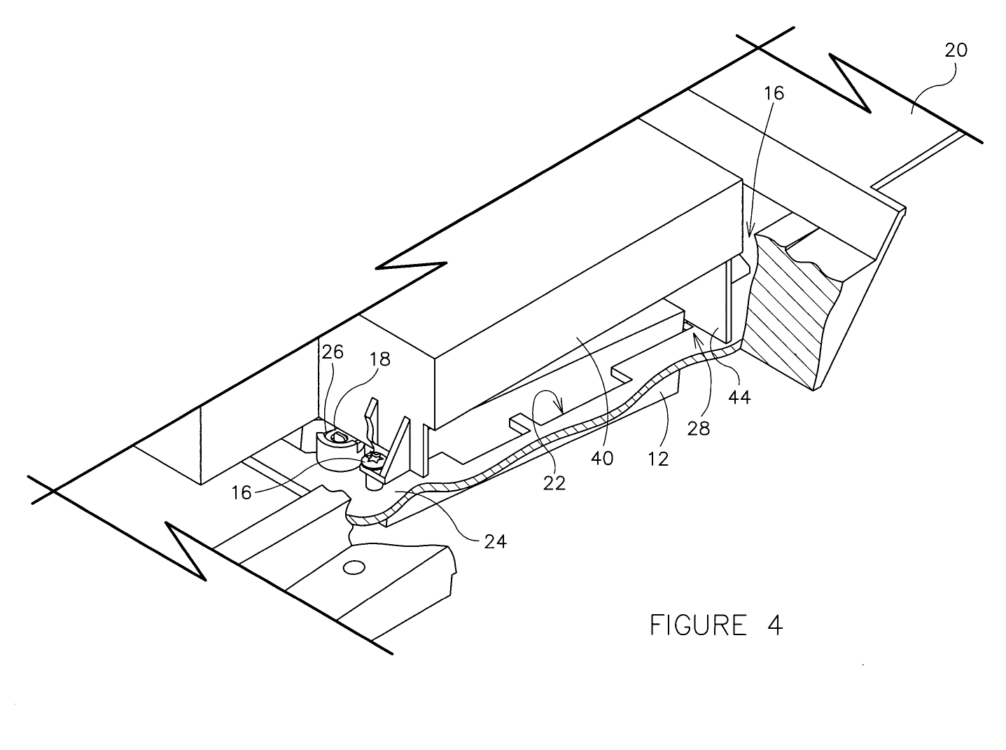

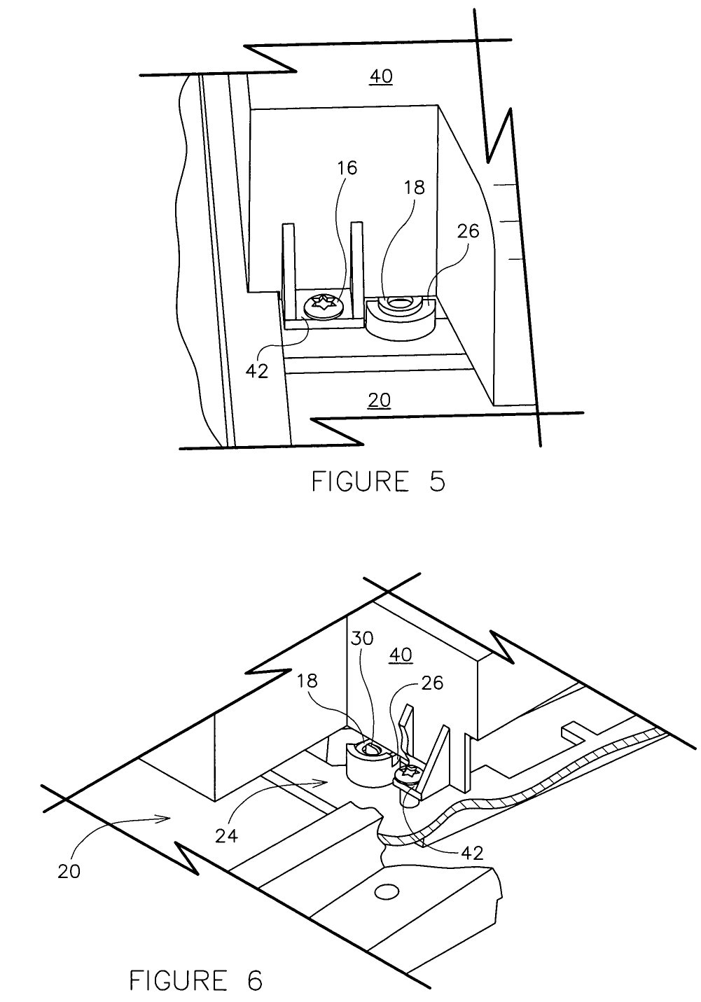

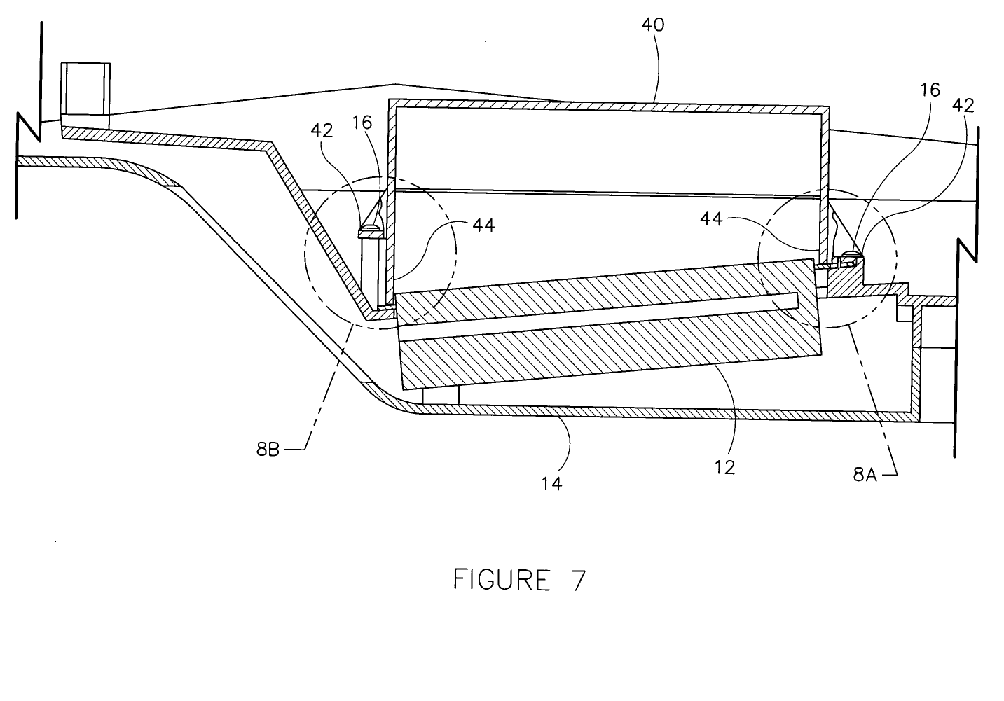

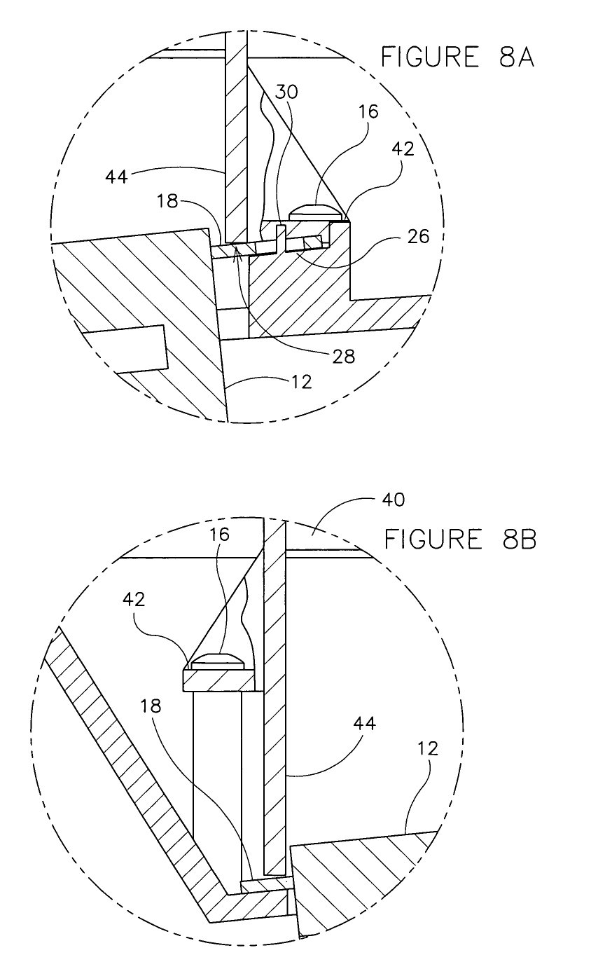

According to a preferred embodiment, base 20 includes a platform portion 24 configured to interface with mounting structure 18 (e.g. flanges, extensions, projections, etc.—shown in FIGS. 4 through 6 as having openings therein) extending from a body portion of electronic device 12. Platform portion 24 is shown having a first mounting surface 26 and a second mounting surface 28 (e.g. ledge, land, shoulder, etc. as shown schematically in FIGS. 4 through 8). The first and second mounting surfaces 26, 28 are positioned on the platform portion 24 at a location corresponding to mounting structure 18 on electronic device 12. According to an alternative embodiment, a cushion layer (e.g. rubber, foam, etc.) may be provided in the mounting surfaces to provide damping to reduce vibration of the electronic device.

When electronic device 12 is assembled within aperture 22, the mounting structure 18 engages (e.g. overlays, rests upon or is captured by, etc.) the first and second mounting surfaces 26, 28 on the platform section 24 of base 20, so that the body portion of the electronic device 12 is positioned within the aperture 22 and is suspended or otherwise positioned in a non-contact relationship with the concealed side of housing 14. The mounting surfaces 26, 28 may have one or more projections 30 (e.g. posts, tabs, etc.) extending from the surface and configured for positioning within openings on the mounting structure 18. The shape and location of the mounting surfaces 26, 28 and projections 30 are intended to substantially prevent movement of the electronic device in a lateral direction (i.e. along a plane generally parallel to the plane of the electronic device).

According to a particularly preferred embodiment, base 20 may be provided with a platform portion 24 that is configured for assembly of the electronic device 12 to the base 20 at an “angle” to suit a desired access profile for a user within the vehicle interior to interface with the electronic device 12. According to a preferred embodiment, base 20 is made from plastic (such as ABS plastic, etc.) by a molding process (such as injection molding, etc.) and may be provided in any suitable color to accent a color scheme for the vehicle interior.

Referring to FIGS. 1 through 4, cover 40 is provided in a suitable shape and contour for assembly to the base 20 or housing 14 and to retain (e.g. capture, clamp, “sandwich,” etc.) the electronic device 12 in position on the base 20. The cover 40 is shown having a size generally configured to cover the aperture 22 and the electronic device 12. The cover 40 includes connection devices shown as tabs 42 (e.g. flanges, etc.) and is assembled (e.g. fixed, secured, mounted, etc.) to the base 20 by connectors 16 (shown schematically as threaded fasteners) configured to engage the tabs 42 on the cover 40 and bosses or other suitable connecting structure on the base 20. The tabs 42 are positioned on the cover 40 so that assembly of cover 40 to base 20 by the connectors 16 provides a clamping force on the mounting structure 18 of the electronic device 12.

According to a preferred embodiment, the cover 40 includes a clamping member 44 (shown as a “lower” edge that generally surrounds at least a portion of the electronic device along the platform portion) and has portions that correspond to the locations of the mounting structure 18 and the mounting surfaces 26, 28. The clamping member 44 is configured to “clamp” the mounting structure 18 on electronic device 12 between the mounting surfaces 26, 28 on base 20 and the edge of cover 40, and is intended to reduce vibration of the electronic device 12 and to prevent movement of the electronic device 12 along an axis that is generally perpendicular to the plane of the electronic device 12. According to an alternative embodiment, the cover may have openings to permit passage of electrical conductors, or for ventilation. According to another alternative embodiment, the clamping member may have any suitable structure configured to hold (e.g. capture, “sandwich,” restrain, etc.) the electronic device within the base. According to a further alternative embodiment, a cover may be omitted and a “bezel” or other member suitable for clamping the electronic device against the base may be provided.

According to any preferred embodiment, the system and method for mounting in-vehicle electronics provides a low-cost system for mounting an electronic device within a vehicle interior and includes structure for “clamping” projections extending from a commercially-available electronic device as an assembly between a base and a cover of a trim piece that is securable within a vehicle interior. The electronic device is supported in the “clamped” configuration so that movement of the electronic device relative to the trim piece is substantially prevented, and so that a surface (shown as a “bottom” surface) of the electronic device is elevated or otherwise positioned to substantially prevent contact of the surface of the electronic device with other surfaces or structures of the vehicle interior. The system and method for mounting in-vehicle electronics permits an electronic device to be rapidly and conveniently configured for installation within a vehicle interior in a manner that avoids the use of threaded fasteners that directly engage the electronic device and that minimizes vibration of the electronic device during operation within the vehicle interior.

It is important to note that the construction and arrangement of the of the various embodiments of the system and method for mounting in-vehicle electronics provided herein is illustrative only. Although only a few exemplary embodiments of the present inventions have been described in detail in this disclosure, those skilled in the art who review this disclosure will readily appreciate that many modifications are possible in these embodiments (such as variations in shape and size of the housing, base and cover; location, orientation or positioning of the electronic device; different types of electronic devices; various locations for mounting within the vehicle; location, configuration and engagement patterns of the mounting surfaces and mounting structure, etc.) without materially departing from the novel teachings and advantages of the inventions. Further, the system and method for mounting in-vehicle electronics may be used in any type of vehicle such as trucks, recreational vehicles, minivans, sport utility vehicles, passenger automobiles, etc. and at any suitable location within the vehicle. Accordingly, all such modifications are intended to be within the scope of the invention as defined in the appended claims.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

1. A mounting structure for an electronic device adapted for use in a vehicle interior, comprising:
a base coupled to a structure of the vehicle interior and having an aperture therein;
a cover coupled to the base;
so that at least one projection extending from the electronic device is clamped between the base and the cover when the electronic device is positioned in the aperture and the cover is coupled to the base.

2. The mounting structure of claim 1 wherein the base includes a platform portion having at least one mounting surface formed thereon so that the projection overlays the mounting surface when the electronic device is assembled on the base.

3. The mounting structure of claim 1 wherein the cover further comprises a clamping member configured to retain the electronic device on the base.

4. The mounting structure of claim 3 wherein the clamping member comprises an edge of the cover.

5. The mounting structure of claim 1 wherein the cover is coupled to the base by fasteners.

6. The mounting structure of claim 5 wherein a body portion of the electronic device is substantially free of engagement with the fasteners.

7. The mounting structure of claim 1 wherein an underside of the body portion of the electronic device is substantially free of contact with any component within the vehicle interior.

8. The mounting structure of claim 1 wherein the mounting surface is configured to position the electronic device at an angle relative to the base.

9. A method of assembling an electronic device having at least one projection for mounting in a vehicle interior, comprising:
coupling a base to an portion of the vehicle interior, the base having a platform portion configured for placement of the projection thereon; and
coupling a cover member to the base so that the projection is captured between the platform and the cover member and a surface of the electronic device is substantially free of contact with the base and the housing.

10. The method of claim 9, wherein the platform portion further defines an aperture for positioning the electronic device therein.

11. The method of claim 9 wherein the platform portion further comprises at least one mounting surface adjacent the aperture and configured to engage the projection.

12. The method of claim 9 wherein the cover member further comprises an edge configured to sandwich the projection between the cover and the mounting surface when the cover member is coupled to the base.

13. The method of claim 11 wherein the mounting surface comprises a post configured to engage an opening in the projection.

14. The method of claim 9 wherein the electronic device is a DVD device and the surface is an underside of the DVD device.

15. A system for mounting an electronic device in a vehicle interior, comprising:
a base member having an aperture configured to receive the electronic device therein;
at least one mounting surface provided on the base member adjacent the aperture;
a mounting structure extending from a body portion of the electronic device and configured to interface with the mounting surface; and
a cover having a clamping portion configured to secure the mounting structure between the mounting surface and the cover when the cover is coupled to the base member.

16. The system of claim 15 wherein the body portion of the electronic device has a bottom surface that is substantially free of contact with the base member and the cover.

17. The system of claim 15 wherein mounting surface at least partially surrounds the aperture.

18. The system of claim 15 wherein the mounting surface includes a projection configured to engage an opening in the mounting structure when the electronic device is positioned in the aperture.

19. The system of claim 15 wherein the electronic device is a DVD device.

20. The system of claim 15 wherein the cover further comprises at least one connection device for coupling the cover and the base member and is positioned so that the clamping portion provides a clamping force on the mounting structure when the cover is coupled to the base.

21. The system of claim 15 further comprising a housing having a first attachment structure for coupling to the base member and a second attachment structure adapted to couple to a structure within the vehicle interior.

22. The system of claim 21 wherein the structure is an overhead panel in the vehicle interior.

23. The system of claim 15 wherein the mounting surfaces are adapted to restrain movement of the electronic device in a direction generally parallel to a plane of the electronic device.

24. The system of claim 15 wherein the cover is coupled to the base member by fasteners and the electronic device is substantially free of contact with the fasteners.

25. The system of claim 15 wherein the mounting surface is configured to orient the electronic device at an angle relative to the base member.
